(19) United States
(12) Patent Application Publication
(10) Pub. No.: US 2009/0313421 A1
(43) Pub. Date: Dec. 17, 2009

(54) Data Update Method and Electronic Device Using Such Data Update Method

(75) Inventor: Zheng-Tie Sun, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/265,964

(22) Filed: Nov. 6, 2008

(30) Foreign Application Priority Data
Jun. 17, 2008 (CN) 200810099643.0

(51) Int. Cl. G06F 12/02; G06F 12/00

(52) U.S. Cl. 711/103; 711/E12.001; 711/E12.008

(57) ABSTRACT

A data update method is provided for updating the data stored in a memory unit of an electronic device. The data update method includes the following steps. In response to a data update request, a data content indexing table is read from the memory unit. According to the data content indexing table, position information associated with the portion of the data to be updated is computed. According to the position information, the portion of the data to be updated is updated.

### FIELD OF THE INVENTION

The present invention relates to a data update method, and more particularly to a data update method for updating the data stored in a memory unit of an electronic device.

### BACKGROUND OF THE INVENTION

Optical discs such as compact discs (CDs) and digital versatile disc (DVDs) are widely employed to store considerable digital data due to features of low cost, high capacity and easy portability. In views of the readable and rewritable functions, CD-RW disc and DVD+RW/-RW disc are developed that data can be added and removed data up to many times; and CD-R and DVD+R/-R are once-writable optical discs. Moreover, according to different production lines of different manufacturers and the diverse formulae or compositions of the photosensitive dyes coated on the optical discs, the sensitivity and the quality of the optical discs are varied. Under this circumstance, if different writable optical discs are used by different disc burners, some drawbacks occur and thus the sensitivity and the quality of the optical discs are deteriorated. These drawbacks include, for example, disc write error or disc read error.

For solving these drawbacks, the manufacturers of the disc burners often collect all kinds of commercial optical discs and then the writing strategies for these optical discs are managed and identified. The writing strategies are gathered into a writing strategy table, which is stored in the firmware of the disc burner. For adjusting laser power to fit different types or specifications of optical discs, a so-called optimum power calibration (OPC) procedure is developed for creating the writing strategy table. Before the disc burner writes data into a writable disc, the representative serial number of the writable disc is checked. According to the representative serial number, corresponding burning parameters are searched from the writing strategy table. Then, under these burning parameters, the disc burner performs the optimum power calibration procedure by burning the writable disc at an optimum power level. The above approach can be used in many disc burners produced by different manufacturers to write data into most commercial writable discs. In a case that the representative serial number of a writable disc does not fit the writing strategy table, the general disc burners may write data into the writable disc according to a built-in default writing strategy.

Since new types of optical discs are more rapidly developed in comparison with all commercial disc burners, the manufacturers of the disc burners fail to collect all optical discs and thus the writing strategy tables does not contain the writing strategies of all optical discs. For example, the early-stage disc burners usually fail to successful write data into the new-generation optical disc in the optimum power calibration procedure. For solving such a problem, it is necessary to adjust the writing strategy table of the disc burners. The disc burner manufactures adjust and update the writing strategy table and the updated firmware program data containing the new writing strategy table can be downloaded by the user through the internet so as to update the firmware data of their own disc burner.

Generally, the writing strategy table is stored in the firmware of the disc burner in arrays. In addition, the firmware program data of the disc burner further comprises a normal code for controlling and driving basic reading and writing operation of the disc burner. Since the writing strategy table and the normal code are mixed as the firmware program data of the disc burner, the old writing strategy table and the old normal code are erased and then the new firmware program data are written during the process of updating the firmware data. Since the deteriorated burning quality occurs in most situations, the process of updating the writing strategy table is needed but the time-consuming process of updating the normal code is not necessary. If the writing strategy table and the normal code are both updated, the risks of resulting in accidental crash of the computer system or causing errors are increased during the process of updating the normal code.

Therefore, there is a need of providing an improved data update method to obviate the drawbacks encountered from the prior art.

### SUMMARY OF THE INVENTION

The present invention provides a data update method for updating the data stored in a memory unit of an electronic device

In accordance with an aspect of the present invention, a data update method for updating the data stored in a memory unit of an electronic device is provided. The data update method includes steps of: reading a data content indexing table from the memory unit in response to a data update request, computing position information associated with the portion of the data to be updated according to the data content indexing table, and updating the portion of the data according to the position information.

In accordance with another aspect of the present invention, an electronic device is provided. The electronic device includes a memory unit and a control unit. The memory unit stores a data. The data includes a data content indexing table. The control unit is communicated with the memory unit. The control unit reads the data content indexing table from the memory unit in response to a data update request, computes position information associated with the portion of the data to be updated according to the data content indexing table, and updates the portion of the data according to the position information.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic block diagram illustrating an electronic device using a data update method according to a preferred embodiment of the present invention;

FIG. 1B is a schematic block diagram illustrating the flash memory of the disc reading and writing device;

FIG. 2 is a schematic flowchart illustrating a data update method of the present invention; and

FIG. 3 is a schematic functional block diagram illustrating a data update method of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

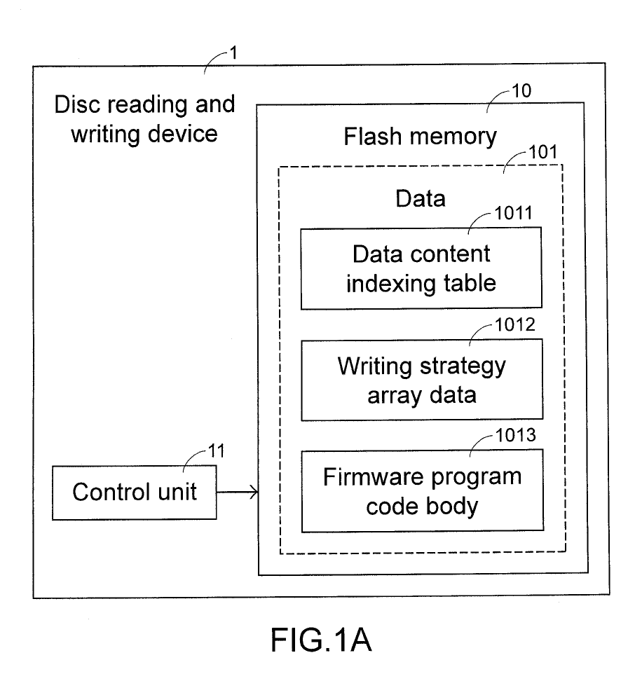

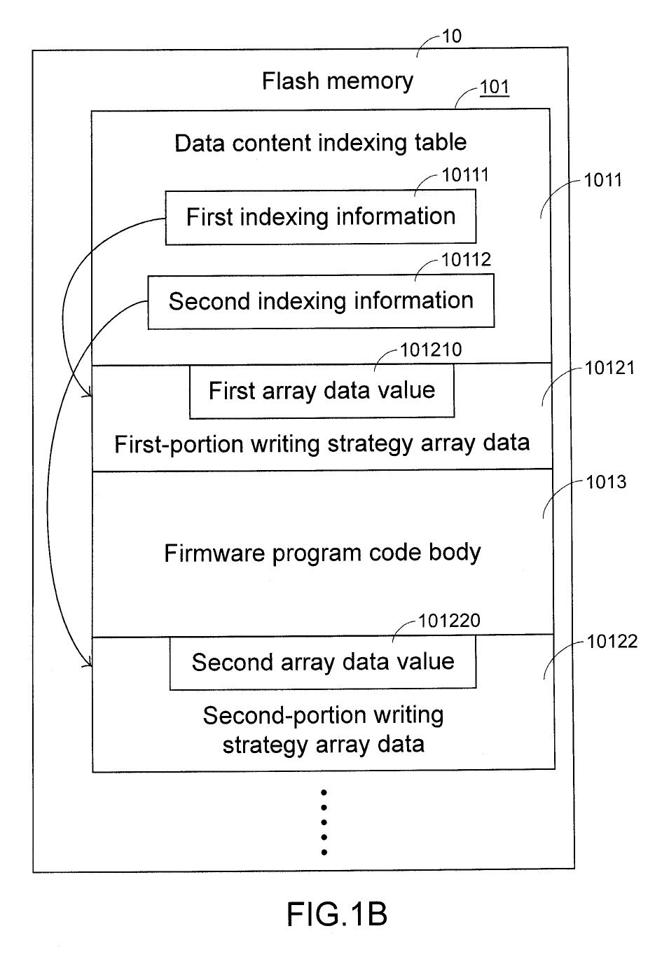

FIG. 1A is a schematic block diagram illustrating an electronic device using a data update method according to a preferred embodiment of the present invention. An exemplary electronic device 1 of FIG. 1A is a disc reading and writing device. The disc reading and writing device 1 principally comprises a flash memory 10 and a control unit 11. The flash memory 10 is communicated with the control unit 11. A data 101 is stored in the flash memory 10. The data 101 comprises a data content indexing table 1011, a writing strategy array data 1012 and a firmware program code body 1013. The data update method of the present invention principally comprises the following steps. First of all, the control unit 11 reads the data content indexing table 1011 in response to a data update request. Next, according to the contents of the data content indexing table 1011, the position information associated with a portion of the data to be updated is computed. Next, according to the position information, the portion of the data is updated. In particular, if the portion of the data to be updated is the writing strategy array data 1012, only the writing strategy array data 1012 is updated and the firmware program code body 1013 is not updated. As previously described, the conventional data update method needs to update all of the data stored in the memory. On the contrary, the data update method of the present invention may expediently update the portion of the data which is required to be updated and stored in the flash memory 10.

Hereinafter, the data update method of the present invention will be illustrated in more detail with reference to FIG. 1B. FIG. 1B is a schematic block diagram illustrating the flash memory of the disc reading and writing device. As shown in FIG. 1B, the writing strategy array data 1012 includes a first-portion writing strategy array data 10121 and a second-portion writing strategy array data 10122. The first-portion writing strategy array data 10121 and the second-portion writing strategy array data 10122 are dynamically and discontinuously stored on different positions of the flash memory 10. Corresponding to the first-portion writing strategy array data 10121 and the second-portion writing strategy array data 10122, the data content indexing table 1011 includes first indexing information 10111 and second indexing information 10112, respectively. Generally, in views of the positions in the flash memory 10, the data content indexing table 1011 is arranged directly preceding the first-portion writing strategy array data 10121. For updating the first-portion writing strategy array data 10121 stored in the flash memory 10, the control unit 11 firstly reads the first indexing information 10111 contained in the data content indexing table 1011 and then retrieves a first array data value 101210. According to the first array data value 101210, the position information associated with the first-portion writing strategy array data 10121 is computed. Afterwards, the first-portion writing strategy array data 10121 is updated according to the position information associated with the first-portion writing strategy array data 10121. For updating the second-portion writing strategy array data 10122 stored in the flash memory 10, the control unit 11 firstly reads the second indexing information 10112 contained in the data content indexing table 1011 and then retrieves a second array data value 101220. According to the second array data value 101220, the position information associated with the second-portion writing strategy array data 10122 is computed. Afterwards, the second-portion writing strategy array data 10122 is updated according to the position information associated with the second-portion writing strategy array data 10122.

In some embodiments, each of the first array data value 101210 and the second array data value 101220 read by the control unit 11 contains the values of the array dimension number and the array dimension size. When the first array data value 101210 and the second array data value 101220 are read by the control unit 11, the dimension numbers and the dimension sizes of the first-portion writing strategy array data 10121 and the second-portion writing strategy array data 10122 are realized. According to the first array data value 101210 and the second array data value 101220, the position information associated with the first-portion writing strategy array data 10121 and the position information associated with the second-portion writing strategy array data 10122 are respectively computed. For example, if the first array data value 101210 is read by the control unit 11 to realize that the first-portion writing strategy array data 10121 is three-dimensional and the dimension sizes are respectively 3, 5 and 3, the overall array number of the first-portion writing strategy array data 10121 is equal to the product of all dimension sizes, i.e. 3×5×3=45. If the portion of data to be updated is the data having dimension sizes of 2, 3 and 1 and is included in the first-portion writing strategy array data 10121, the portion of data to be updated is located at the 40^{th} position (2×5×3+3×3+1=40) of the 45 overall arrays. Next, the data stored at the 40^{th} position are updated. By the above procedures, the data included in the first-portion writing strategy array data 10121 at the remaining positions are updated.

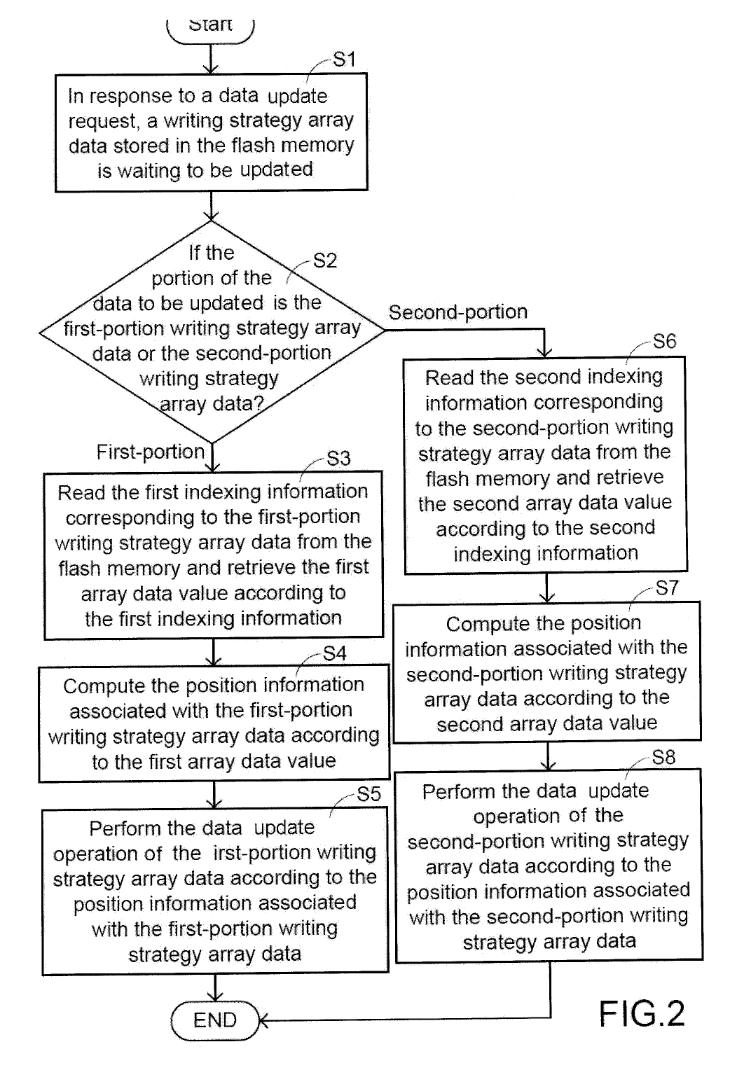

Hereinafter, the data update method of the present invention will be illustrated with reference to a flowchart of FIG. 2 and the block diagrams of FIGS. 1A and 1B. First of all, in response to a data update request, the control unit 11 of the disc reading and writing device 1 is waiting to perform a data update operation of the writing strategy array data 1012 which is stored in the flash memory 10 (Step S1). Next, the control unit 11 discriminates whether the portion of the data to be updated is the first-portion writing strategy array data 10121 or the second-portion writing strategy array data 10122 (Step S2). If the portion of the data to be updated is the first-portion writing strategy array data 10121, the control unit 11 reads the first indexing information 10111 corresponding to the first-portion writing strategy array data 10121 from the flash memory 10 and then the first array data value 101210 is retrieved according to the first indexing information 10111 (Step S3). Next, the control unit 11 computes the position information associated with the first-portion writing strategy array data 10121 according to the first array data value 101210 (Step S4). Afterwards, the control unit 11 performs the data update operation of the first-portion writing strategy array data 10121 according to the position information associated with the first-portion writing strategy array data 10121 (Step S5). Similarly, if the portion of the data to be updated is the second-portion writing strategy array data 10122, the control unit 11 reads the second indexing information 10112 corresponding to the second-portion writing strategy array data 10122 from the flash memory 10 and then the second array data value 101220 is retrieved according to the second indexing information 10112 (Step S6). Next, the control unit 11 computes the position information associated with the second-portion writing strategy array data 10122 according to the second array data value 101220 (Step S7). Afterwards, the control unit 11 performs the data update operation of the second-portion writing strategy array data 10122 according to the position information associated with the second-portion writing strategy array data 10122 (Step S8).

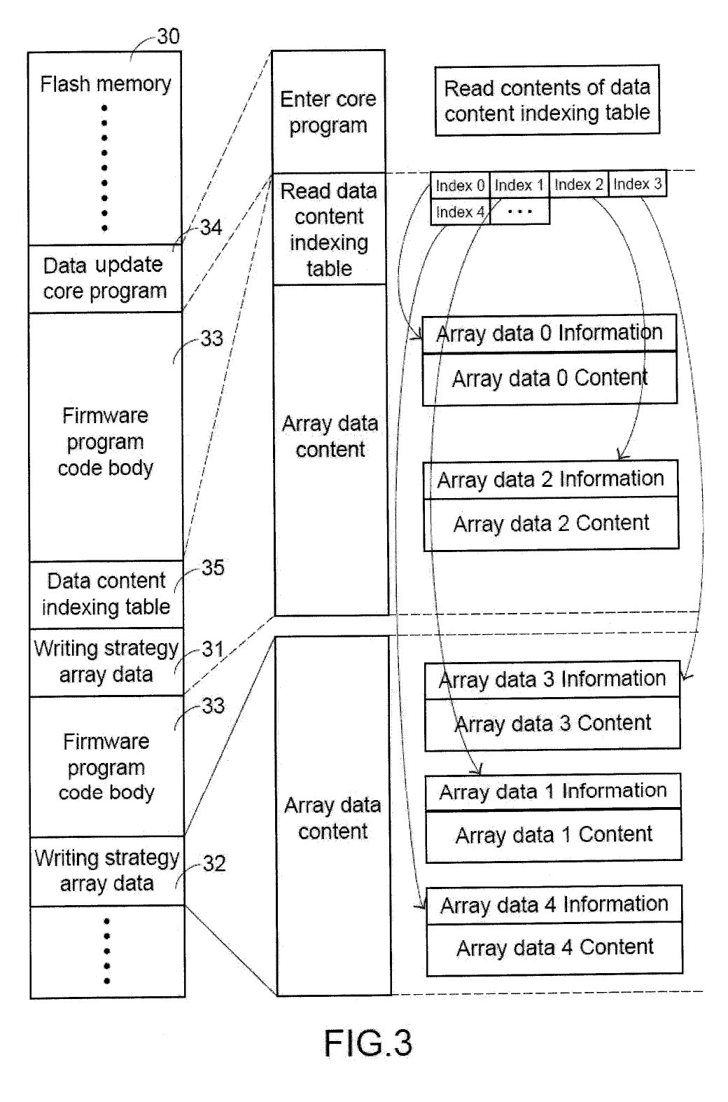

The data update method of the present invention is also illustrated by the functional block diagram shown in FIG. 3. As shown in FIG. 3, writing strategy array data 31 and 32 are dynamically stored in discontinuous positions of the flash memory 30. For preventing from simultaneously updating the firmware program code body 33 while the writing strategy array data 31 and 32 are updated, a data update core program 34 should be read in response to the data update request. After the data update core program 34 is executed, the contents of the data content indexing table 35 are read. The contents of the data content indexing table 35 include, for example, Index 0, Index 1, Index 2, Index 3 and Index 4. That is, the contents of the data content indexing table 35 includes the first indexing information 10111 and the second indexing information 10112 described in FIGS. 1A and 1B. In this embodiment, Index 0, Index 1, Index 2, Index 3 and Index 4 correspond to Array data 0 Information, Array data 1 Information, Array data 2 Information, Array data 3 Information and Array data 4 Information of the writing strategy array data 31 and 32, respectively. The relations described above are similar to the first indexing information 10111 and the second indexing information 10112 corresponding to the first array data value 101210 and the second array data value 101220, respectively as shown in FIG. 1B. According to the array data value (e.g. the array dimension number and the array dimension size) corresponding to the portion of writing strategy array data to be updated, the position information associated with the portion of writing strategy array data to be updated is computed. Afterwards, according to such position information, the contents of the writing strategy array data (e.g. Array data 0 Content, the Array data 1 Content, Array data 2 Content, Array data 3 Content and Array data 4 Content) are updated.

As previously described, the conventional data update method needs to erase all of the data stored in the memory and then write the new data into the memory. On the contrary, the data update method of the present invention may expediently update a certain portion of the data stored in the memory which is required to be updated. As a consequence, the risks of resulting in accidental crash of the computer system or causing errors are largely decreased during the data update process.

The above embodiments are illustrated by referring to a disc reading and writing device. Nevertheless, the data update method of the present invention can be used in other electronic electrical device containing the memory unit such as a mobile phone, a personal digital assistant (PDA) or a printer.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data update method for updating the data stored in a memory unit of an electronic device, the data update method comprising steps of:
reading a data content indexing table from the memory unit in response to a data update request;
computing position information associated with the portion of the data to be updated according to the data content indexing table; and
updating the portion of the data according to the position information.

2. The data update method according to claim 1 wherein the electronic device is a disc reading and writing device, the memory unit is a flash memory, and the data stored in the memory unit includes a writing strategy array data.

3. The data update method according to claim 2 wherein the data stored in the memory unit includes a firmware program code body for controlling a data writing operation of the disc reading and writing device.

4. The data update method according to claim 2 wherein the writing strategy array data includes a first-portion writing strategy array data and a second-portion writing strategy array data, and the data content indexing table includes a first indexing information and a second indexing information corresponding to the first-portion writing strategy array data and the second-portion writing strategy array data, respectively.

5. The data update method according to claim 4 further comprising steps of:
reading the first indexing information of the data content indexing table from the flash memory in response to the data update request;
retrieving a first array data value according to the first indexing information;
computing the position information associated with the first-portion writing strategy array data according to the first array data value; and
updating the first-portion writing strategy array data according to the position information associated with the first-portion writing strategy array data.

6. The data update method according to claim 4 further comprising steps of:
reading the second indexing information of the data content indexing table from the flash memory in response to the data update request;
retrieving a second array data value according to the second indexing information;
computing the position information associated with the second-portion writing strategy array data according to the second array data value; and
updating the second-portion writing strategy array data according to the position information associated with the second-portion writing strategy array data.

7. The data update method according to claim 5 wherein the first array data value and the second array data value include the values of the array dimension number and the array dimension size.

8. The data update method according to claim 6 wherein the first array data value and the second array data value include the values of the array dimension number and the array dimension size.

9. The data update method according to claim 4 wherein the first-portion writing strategy array data and the second-portion writing strategy array data are dynamically stored in discontinuous positions of the flash memory.

10. The data update method according to claim 1 wherein the electrical device is a mobile phone, a personal digital assistant or a printer.

11. An electronic device comprising:
a memory unit for storing a data, wherein the data comprising a data content indexing table; and
a control unit for communicating with the memory unit, reading the data content indexing table from the memory unit in response to a data update request, computing position information associated with the portion of the data to be updated according to the data content indexing table, and updating the portion of the data according to the position information.

12. The electronic device according to claim 11 wherein the electronic device is a disc reading and writing device, the memory unit is a flash memory, and the data stored in the memory unit includes a writing strategy array data.

13. The electronic device method according to claim 12 wherein the data stored in the memory unit includes a firmware program code body for controlling a data writing operation of the disc reading and writing device.

14. The electronic device according to claim 12 wherein the writing strategy array data includes a first-portion writing strategy array data and a second-portion writing strategy array data, and the data content indexing table includes first indexing information and second indexing information corresponding to the first-portion writing strategy array data and the second-portion writing strategy array data, respectively.

15. The electronic device according to claim 14 wherein the control unit reads the first indexing information of the data content indexing table from the flash memory in response to the data update request, retrieves a first array data value according to the first indexing information, computes the position information associated with the first-portion writing strategy array data according to the first array data value, and updates the first-portion writing strategy array data according to the position information associated with the first-portion writing strategy array data.

16. The electronic device according to claim 14 wherein the control unit reads the second indexing information of the data content indexing table from the flash memory in response to the data update request, retrieves a second array data value according to the second indexing information, computes the position information associated with the second-portion writing strategy array data according to the second array data value, and updates the second-portion writing strategy array data according to the position information associated with the second-portion writing strategy array data.

17. The electronic device according to claim 15 wherein the first array data value and the second array data value include the values of the array dimension number and the array dimension size.

18. The electronic device according to claim 16 wherein the first array data value and the second array data value include the values of the array dimension number and the array dimension size.

19. The electronic device according to claim 15 wherein the first-portion writing strategy array data and the second-portion writing strategy array data are dynamically stored in discontinuous positions of the flash memory.

20. The electronic device according to claim 11 wherein the electrical device is a mobile phone, a personal digital assistant or a printer.
